(19) United States
(12) Patent Application Publication
(10) Pub. No.: US 2015/0287156 A1
(43) Pub. Date: Oct. 8, 2015

(54) Methods and Apparatuses for Robust Watermarking in Multimedia Content

(71) Applicant: Anthony Mai, San Marcos, CA (US)

(72) Inventor: Anthony Mai, San Marcos, CA (US)

(73) Assignee: Anthony Mai, San Marcos, CA (US)

(21) Appl. No.: 14/246,050

(22) Filed: Apr. 5, 2014

(51) Int. Cl. G06T 1/00; H04N 19/467

(52) U.S. Cl. CPC G06T 1/005; H04N 19/467

(57) ABSTRACT

Methods and apparatuses for embedding watermark information into multimedia contents like audio, imagery or video, and for detection of such watermarks from embedded multimedia content. A two step embedding approach is proposed wherein the watermark bits are first used to construct a modulation signal. Said modulation signal is used to modify certain selected characteristics of the media content. A detector is then used to first extract the modulation signal from embedded media content, and then to extract watermark information from the modulation signal extracted. This current invention enhances watermark robustness against classes of attacks that prior arts are vulnerable to resist. Current invention is novel and useful in any multimedia application fields, including but not limited to the identification, distribution tracking and copyright protection of audio, imagery and video contents.

### FIELD OF INVENTION

The current invention relates to the field of intelligence, security, forensics, steganography and communication. One particular field is the embedding a watermark in audio content so as to provide identifying information pertaining to the audio content. Another field is in clandestine communication through audio content. The current invention can be used in multimedia content copyright protection and distribution tracking; or be used by spy agents to deliver secret information through regular telephone networks; or be used to broadcast emergency signal to a large population, or for other purposes.

### BACKGROUND OF INVENTION

Communication is the process of delivering specific information from a sender to a receiver using a signal channel like a computer network or a wireless radio. Steganography is a special form of communication by camouflaging secret information within other information content that is being communicated to deliver said secret information to intended receiver undetected by any party not familiar with the specific methods of camouflaging. Specifically, steganography messages called audio watermarks can be embedded in audio contents or the audio portion of video contents for later retrieval.

An audio watermark is an information package. Information is represented by a series of bits 1s and 0s. In most forms of communication, such an information carrying series of bits is sequentially applied to a carrier signal which is delivered to a receiver to recover the series of bits in the same sequentially order. Hopefully the time sequence order is maintained, and the bit sequence received is identical to the one originally sent, and the information recovered is identical to the information originally sent.

Various audio watermark methods have been proposed and put into practice. Typically, such prior arts naively treat the host audio content as a conventional communication channel. The bits from an audio watermark are sequentially embedded into the host audio content, using various methods and algorithms. The sequentially embedded bits are then sequentially recovered at the receiver using the corresponding recovery algorithm. A complete watermark package, exactly identical to the one originally embedded, is then reconstructed from the bits recovered.

The audio content goes through various processing before it is received, including compression, filtering, and/or deliberate manipulations in an effort to erase the watermark. Thus it is expected that a small portion of the watermark bits may not be recovered correctly. To ensure reliable watermark detection, watermark packages are typically very big. They contain one hundred or more bits but carry very little payload information. This is so that the incorrect bits can be corrected using forward error correction algorithms due to the built-in information redundancy in the watermark package.

Another consideration in designing an effective audio watermark method is that the artifacts introduced by embedding must not be audible to human ears, and must not be noticeable to attackers who attempt to analyze the audio content to identify such artifacts and figure out the secret of embedding. Thus the bit embedding must be quickly varying in a semi-random fashion, as human ears are not sensitive to quick variations in sound. This fact, and the fact that watermark packages generally contain hundreds of bits, means the bits must be tightly embedded close to each other in time scale. As a matter of facts, typical watermark bits are embedded in segments of audio of only about 20 milliseconds in length, while the entire watermark package can expand over a length of 2 to 5 seconds of audio.

Such audio watermark designs are inherently weak and vulnerable to a class of watermark attacks called desynchronization attack, or more specifically, time scale modification attack. The reason is the detector, having to identify hundreds of individual bits tightly packed with a mere 20 milliseconds gap between individual bits, and not being able to identify any boundary between the bits, must blindly assume all the bits are uniformly distributed at the positions that can be precisely calculated based on known bit length.

However an attacker can randomly modify the time scale of the audio content, nudging some parts of the audio slightly ahead and some other parts slightly behind. Such gentle nudging is hardly noticeable to human ears, but it causes the detector to extract the wrong bits from wrong positions. As a result, a good portion of bits turn out to be wrong. Since forward error correction code can only handle cases in which number of error bits must be below a low threshold, the detector is unable to identify any watermark.

Time scale modification attacks are very effective. The time warping method only needs to nudge the audio forward or backward for slightly more than one bit's length, to cause the detector to recognize the bit at a wrong position offset by one. Assuming ⅓ of the bits are detected at the correct position, and are 100% correct; ⅓ of the bits are positioned offset by −1, and have a random 50% chance of being correct; and ⅓ of the bits are positioned offset by +1, and are also correct 50% of the time. In such a case, all the bits have a ⅓*100%+⅓*50%+⅓*50%=66.7% chance of being correct. There is a bit error rate of 33.3%, which is more than what any forward bit error correction code can handle. For example a 127 bits BCH code with 50 bits payload can handle no more 13 error bits, or 10.2% error bits. A web site that provides many error code correction methods can be found at: http://www.eccpage.com/

The watermarking industry has long struggled with the open question of dealing with desynchronization attacks and time scale modification attacks with no good solution. Clearly a new watermark method that does not depend on embedding bits sequentially, is novel, non-obvious, and very useful to the industry.

### SUMMARY OF INVENTION

The present invention provides methods and apparatuses for embedding watermarks in audio content. Such embedding causes no audible alternation to the audio content, and is un-detectable to an attacker. Such embedding can be reliably recovered by an informed detector. Such embedding is robust against typical audio processing and deliberate erasures. By providing a novel two step embedding approach, current invention provides significantly enhanced robustness and security over prior arts of watermark embedding methods, and can be used for media content copy protection and other application areas.

According to an embodiment of present invention, watermark embedding involves the following steps:
1. Construct an audio watermark package of N bits, with M payload and (N-M) error correction bits.
2. Assign the watermark bits to a plural of frequency components that will be present for set bits.
3. Construct a periodical embedding signal based on the presence of said frequency components.
4. Use the periodical embedding signal to modulate the carrier host audio signal in certain ways.

The detection process runs in reverse order accordingly:
1. Extract the modulation signal from the carrier host audio content.
2. Calculate the frequency components of the extracted modulation signal.
3. Determine if each frequency components is present, and then assign bit values of 1 or 0.
4. Try to use error correction algorithm to recover the correct whole watermark package.

The periodical embedding signal will have a period length equal to the length of one whole watermark. For example if we want to use a segment of ten seconds of audio to embed one watermark, then the embedding signal will have a fundamental period of ten seconds, and a fundamental frequency of 0.1 Hz.

Each frequency components of the embedding signal will have a frequency which is an integer multiple of the fundamental frequency. For example one component has a frequency of 1*0.1 Hz=0.1 Hz, and another component has a frequency of 2*0.1 Hz=0.2 Hz, and so on, and not necessarily in the bit order.

The watermark bit package is constructed based on the payload information and error correction bits needed. For example we can construct a watermark package of 24 payload bits and 39 error correction bits, based on BCH error correction code algorithm, for a total of 63 bits. Such watermark package is capable of correction no more than 7 error bits, or allowing an error ratio of 7/63=11.1%.

Next, each bit is associated with a frequency component in the embedding signal, but not necessarily in the same sequential order. If the bit is 1, the corresponding frequency component exists and will be added to the embedding signal. If the bit is 0, the corresponding frequency component is not added

Then sinusoidal waveforms of each present frequency are summed up to obtain the embedding signal.

For the actual embedding, we choose characteristics quantity from the original audio. Such a quantity must be random, and seemingly un-correlated to the audio content. For example, we calculate the total energy of all even multiples of a base frequency, and then calculate the total energy of all odd multiples of the same base frequency, and then calculate the ratio of the two to obtain a random value around 1.0. This ratio can then be modulated by enhancing the first group of frequency components by multiplying a modulation factor, and reducing the second group by dividing them by the same modulation factor.

For another example, we calculate the self correlation coefficient of N even delay constants, and the same for N odd delay constants, and the ratio between the two. This ratio randomly fluctuate around 1.0. This is a characteristics value that we seek to modulate using our modulation signal already calculated. This ratio can be modulated by adding a delayed feedback loop to enhance the even delays, while reducing the odd delays. The gain of the feedback loop will be controlled by a modulation factor.

This random looking characteristics quantity can be calculated in many other ways. It must look random and un-correlated to original audio content. It must also be easily modulated as we wish. All feasible methods of selecting such a characteristics quantity, whether explicitly discussed in this document or not, are intended to be included within the scope of the current invention.

As we modulate the chosen characteristics quantity in the host audio signal, using a modulation signal constructed from a watermark, the watermark information is embedded into the host audio signal.

To retrieve the watermark information from embedded host audio signal, we reverse the procedures. We first calculate the characteristic quantity from the host signal. And then extract the modulation signal from the varying characteristics quantity we extracted. From the modulation signal we can calculate coefficients to different frequency components. Those coefficients correspond to individual bits of the original watermark. Finally we use forward error correction algorithm to correct any wrong bits to recover the original watermark. If such recovery is successful, the watermark is detected and recovered. If such recovery is not possible due to too many error bits, it tells us the watermark does not exist.

The essence of current invention is thus described as above. Prior arts of audio watermarking methods try to embed the watermark bits directly into the audio content, and to embed the individual bits down in certain sequential order to allow the detector to recover those bits in the same sequential order. Such conventional watermark embedding methods open the vulnerability to either the individual bits, or the sequential order of the bits, or both, to malicious attacks. An attacker can chose either to identify and destroy individual bits, or leave the individual bits alone but destroy the sequential order of the bits. Either approach will be successful in erasing watermarks from detection. Unfortunately, any counter measure that enhances the surviving robustness of individual bits also exposes and weakens sequential orders of the bits. And any counter measure that enhances the robustness of the bit sequential orders, also exposes the individual bits and makes them more vulnerable to damages. So there is no good way to protect both in the conventional approach of direct watermark bit embedding. The current invention is novel approach that it does not seek to embed watermark bits directly. Instead it incorporates watermark bits into a modulation signal, and then uses the modulation signal to embed into the audio content.

Actual embodiments can vary in specific characteristics quantity chosen for embedding, in specific parameters used for embedding, and in specific forward error correction algorithms used to recover error bits. Further, watermark bits can be encoded into a modulation signal using a plural of methods other than using different frequency components as described here. All such variations or improvements in embodiments are intended to be included within the scope of current invention.

Inventor of present invention is not aware of any prior art in the field multimedia watermarking that are time invariant and can resist desynchronization attacks and time scale modification attacks. For all intent and purpose, the current invention is the first known art that provide robust audio watermarking methods to resist said attack methods. Thus the current invention is superior to any prior art in the same fields.

### BRIEF DESCRIPTION OF DRAWINGS

FIG. 1 shows how an example modulation signal is constructed from an example 63 bits watermark. Based on the bits that are set to 1, corresponding sinusoidal waveforms are calculated for the frequency components, and then summed up to form the periodical modulation signal. In this example, the 63 bits of the watermark are:

100011000111011111101001010010011010110000010001000101101100110.

FIG. 2 shows Example One embodiment of a watermark embedder method or apparatus. The input audio samples are delayed by D samples. The delayed sample is multiplied by the modulation signal and then also by a scaling factor g, before being added to the input audio sample to produce the embedded output.

FIG. 3 shows Example Two embodiment of a watermark detector method or apparatus. The embedded input audio is delayed by D samples, and multiplied with the non-delayed input audio sample, and the multiplications are accumulated to calculate the delayed correlation coefficients. The result is time averaged and Fourier transformed to produce a frequency spectrum from which a preliminary bit pattern is extracted. The bit pattern goes through the forward bit error correction algorithm to attempt to recover the original watermark code. If bit error correction is unsuccessful, the watermark is declared to be not in existence. If the bit error correction is successful, the watermark is declared detected and delivered.

### DETAILED DESCRIPTION OF INVENTION

The current invention provides robust methods and apparatuses to embed a watermark in audio content, and to later extract the said watermark reliably, even though the audio content is modified by processing.

There exists a lot of prior art of embedding watermark information into audio contents. All known prior arts of audio watermarking attempts to embed single bits of 1s or 0s into very narrow segments of audio of roughly 20 milliseconds or more. All such prior arts rely on individual bits being preserved with high possibilities, and that the order of bits is preserved, to be able to extract the original watermark correctly.

Thus all prior arts of audio watermarking methods suffer from weakness and vulnerability in the face of a class of attacks called desynchronization attacks, or more specifically, time scale modification attack. An attacker, without knowing any secret information of how the watermark is embedded, can time warp the host audio signal by pushing some portions of the audio signal slightly forward and other portions slightly backward in time. Such gentle nudging introduces little noticeable artifacts to human ears, but can cause the watermark detector to mis-allocate individual watermark bits. A correctly extracted bit placed at the wrong bit position is an incorrect bit nevertheless and is no better than a random bit.

### A Novel Approach of Two Steps Watermark Embedding

To solve the long open problem of resisting desynchronization and time scale modification attack, a novel watermark embedding method is needed to not concentrate each watermark bit at a specific time spot, but rather spread them out throughout the audio content. That is the principle of current invention.

Instead of embedding digital bits directly into a host audio signal, the current method first construct a periodical analog modulation signal from the intended watermark package. Then the modulation signal is used to modulate the host audio analogically. Thus, since the embedding is done analogically instead of digitally, the embedding signal can never be erased completely from the host audio signal. Given long enough audio content, this repeated embedding signal will show up by statistical averaging, and can be used to extract the original watermark embedded. As the watermark information is contained in the long term frequency components of the periodically repeated embedding signal, it can not be affected by time warping applied, as time warping modifies the phases but not the frequency components of the signal.

Construction of a Modulation Signal from Watermark Bits

According to current claim 1, the audio watermark embedding constitutes of the following steps:
1A. constructing watermark package of N bits of 1s and 0s, containing error correction code;
1B. selecting N frequency components, with each frequency a multiple of a base frequency F;
1C. constructing a periodical modulation signal having a period of 1/F, based on watermark bits and frequency components that are selected, and selected phase of each frequency component;
1D. using the modulation signal to modulate the host audio signal, using phase modulation and other possible modulation method; and
1E. converting the modulated host audio signal into a suitable format for storage and/or delivery.

Let's use Example One to illustrate these steps. Referring to step 1A, we want to embed a watermark of 18 payload bits. We want to have the ability to exam the bits and correct bit errors, too. There are many forward bit error correction algorithms available, for example see web page http://www.eccpage.com.

We will use BCH error correction. We select watermark package of 63 bits and 10 error bits correcting capability. The code we use is BCH(63,18,21) binary code with a generator polynomial:
1010101111001011100101001010110100001100111101

The whole 63 bits watermark package looks like below after generation:
100011000111011111101001010010011010110000010001000101101100110

Referring to step 1B, we use the 63 watermark bits to generate our modulation signal. But first we have to select a base frequency. As it is reasonable to use ten seconds of audio to embed one watermark, we select a base period of 10 seconds. So the base frequency F= 1/10 Hz=0.1 Hz.

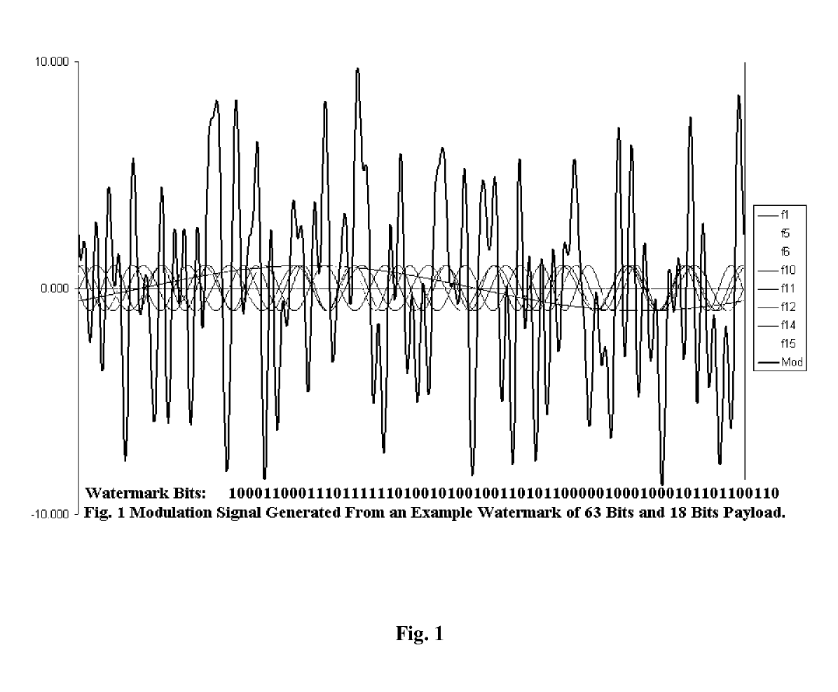

Referring to step 1C, each of the frequency component will have a frequency which is a non-zero integer multiple of F. Let's denote them as f1, f2, f3, . . . f63. Each of them corresponds to a bit in the watermark package. Please refer to FIG. 1 for an illustration. Each one is calculated as a sinusoidal function:

$$F 1 ( t ) = sine ( 2 π * 1 * F * t + θ 1 )$$

$$F 2 ( t ) = sine ( 2 π * 2 * F * t + θ 2 )$$

$$F 3 ( t ) = sine ( 2 π * 3 * F * t + θ 3 )$$

$$…$$

$$F 63 ( t ) = sine ( 2 π * 63 * F * t + θ 63 )$$

Each sinusoidal function contains a phase θ1 through θ63 that are distributed randomly so as to avoid beating, that is avoid exceptionally high peaks at any particular time position when these sinusoidal functions are added. Depending whether each watermark bit is 1 or 0, the corresponding sinusoidal function is added or not added, to construct the modulation signal.

The order of watermark bits can be scrambled but we choose not to. These 63 watermark bits are:
100011000111011111101001010010011010110000010001000101101100110

So the following bits are set and their corresponding sinusoidal functions need to be added:
1, 5,6,10,11,12,14,15,16,17,18,19,21,24,26,29,32,33,35,37,38,44,48,52,54,55,57,58,61,62

Thus we construct our modulation signal by adding the frequency components whose bit is set:

$$Fmod ( t ) = F 1 ( t ) + F 5 ( t ) + F 6 ( t ) + F 10 ( t ) + F 11 ( t ) + F 12 ( t ) + F 14 ( t ) + F 15 ( t ) + F 16 ( t ) + F 17 ( t ) + F 18 ( t ) + F 18 ( t ) + F 21 ( t ) + F 24 ( t ) + F 26 ( t ) + F 29 ( t ) + F 32 ( t ) + F 33 ( t ) + F 35 ( t ) + F 37 ( t ) + F 38 ( t ) + F 44 ( t ) + F 48 ( t ) + F 52 ( t ) + F 54 ( t ) + F 55 ( t ) + F 57 ( t ) + F 58 ( t ) + F 61 ( t ) + F 62 ( t )$$

The entire constructed modification signal is shown in FIG. 1. Remember that our modulation signal is a repeated signal of period 10 seconds. We repeat it as many times as necessary to modulate the entire length of the host audio signal, so the entire audio content is embedded with the same watermark.

### Using the Constructed Modulation Signal to Modulate the Host Audio Signal

Now that the modulation signal is constructed, we refer to step 1D to modulate the host audio signal using our modulation signal. There are a plural of possible methods to modify certain characteristics of the host audio without causing noticeable artifacts. Such modification should be able to survive typical audio processing and be extracted at a receiver so we can calculate how the modification was imposed.

Referring to claim 3, one method of such modulation is modifying the gain of delayed correlation. Let me explain the concept of delayed correlation here. If you multiply one audio sample value with another audio sample value which is delayed by D samples from the first sample value, and accumulate all such multiplications over time, the resulting value is called delayed correlation coefficient, with D being the delay constant. This delay correlation coefficient tells us the relative strength of the portions of audio frequency that is in-phase, i.e., enhancing, after a D sample delay, versus those that are out of phase after a D sample delay. This quantity should be random in natural audio, and so it averages out to zero over long time. However we can modulate this quantity to carry useful information.

We modulate this delayed correlation coefficient by adding to the host signal a feedback delayed by D samples, the gain of the feedback is controlled by multiplying by the modulation signal obtained before.

Selection of this delay constant will be kept as a secret. Since human voice is concentrated within the frequency range from 1000 to 4000 Hz, we would want to choose the delay constant at the low end of hearing threshold. The reason is if the frequency is completely inaudible, it will be discarded by typical audio compression code. But if it is too sensitively audible, the artifacts will be heard by human ears.

### Watermark Embedding Example

For our example we choose a delay frequency of 550 Hz. At a standard 44.1 KHz audio sampling rate, that corresponds to a delay constant D=44100/550=80 samples.

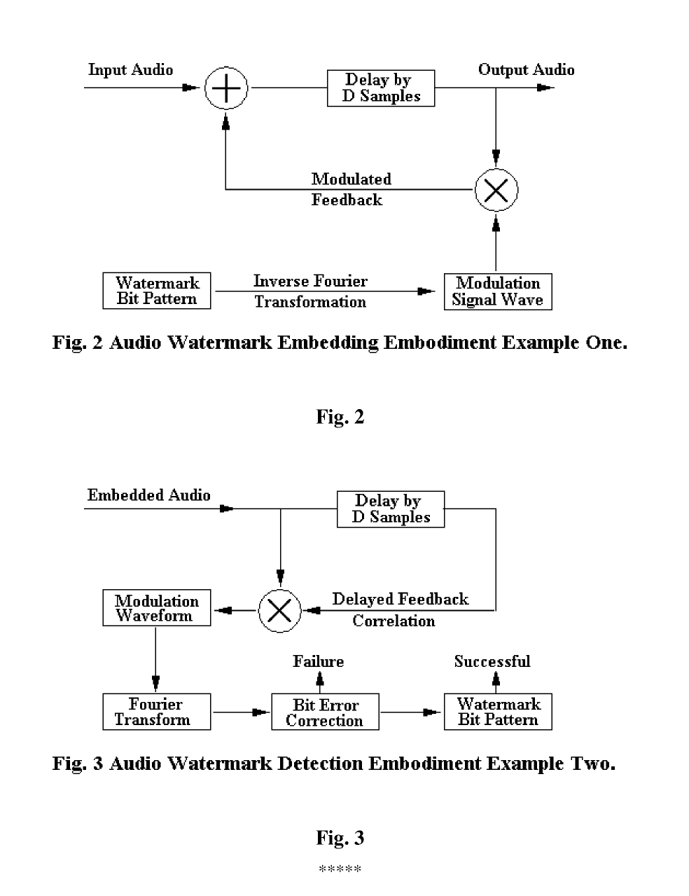

Please refer to FIG. 2 for embodiment Example One. The host audio signal is modulated as below:

Output(t)=Input(t)+g*Fmod(t)*Input(t−d)

Here Input(t) is the original audio signal, Input(t-d) is the original audio signal delay by d, Output(t) is the modulated audio signal. The Fmod(t) is the modulation function we calculated previously. The g is a constant scaling factor chosen by experiment. If g is set too high, there will be too much artifacts in the audio. If g is set too low, then the watermark signal is not strong enough to be detected. Experiments show that g=0.5 is an adequate choice in the embodiment Example One.

The above described a possible embodiment Example One according to claim 3. There are however many other methods of identifying a target characteristics quantity in the host audio signal for periodical modulation and for extraction of such modulation signal, including but not limited to the method in according claim 5, where frequency spectrum of the host audio signal is partitioned into two equal groups, and modification is then applied to enhance one group while reducing the other group. All the variations and improvements of embodiments to identify and then modulate a target characteristics quantity using a modulation signal calculated from a watermark pattern are intended to be included within the scope of current invention.

Likewise, the example above discussed a method of constructing a modulation signal from a watermark package, in accordance to claim 1 step 1C, by assigning each watermark bits to a frequency component and then sum up all frequency components whose corresponding watermark bits are set to 1. But there are other possible variations and improvements in which a modulation signal is constructed in different ways. All such variation and improvement in embodiments constructs a modulation signal based on the watermark bits. Such modulation signal carries the information of the watermark bits. Thus all such varied or improved embodiments are intended to be included within the scope of current invention.

### Watermark Detection Example

Having described an audio watermark embedding embodiment Example One as above, let me explain an audio watermark detection embodiment Example Two. Please refer to FIG. 3 for an illustration.

The embedded audio input is put into a buffer and delayed for D samples. The delayed sample is fetched and multiplied with the current input sample. The multiplication result is then accumulated, sample by sample. Result of this production-and-accumulation, after averaging over time and proper scaling, is called delayed correlation coefficient. This delayed correlation coefficient carries information of the original modulation signal, which we want to extract to obtain the watermark pattern.

Still referring to FIG. 3, we calculate the frequency spectrum of the delayed correlation coefficient signal by Fourier transformation. The result gives us coefficients for each of the frequency components. Such result allows us to calculate the energy level of each frequency components, averaged over time.

We construct a bit pattern based on energy level of each of the frequency components. The ones with an energy level higher than a threshold is assigned a bit 1, and the ones with an energy level lower than the threshold is assigned a bit 0. The threshold level is determined experimentally to ensure bit accuracy.

Once a preliminary bit pattern is constructed, we then utilize forward bit error correction algorithms to attempt to correct any bit errors. In our specific embodiment Example Two, the BCH forward error correction code is used. There are two possible outcomes. First there may be too many bit errors for the bit error correction code to produce a result. In such a case, the watermark is declared either non-exist, or damaged beyond recognition. The second outcome is the bit error correction is successful, and the watermark is declared detected and extracted. The watermark payload is them delivered for processing.

### Novelty and Usefulness of Current Invention

In summary, the novelty of the current invention lies in the fact that prior arts of multimedia watermark embedding take the approach of embedding individual watermark bits directly into the media content, and watermark bits are embedded in certain sequential order into different parts of the media content. The current invention takes a different approach by not embedding the watermark bits directly into the media content. Instead it first embeds and incorporates all watermark bits into a modulation signal. Then it uses the modulation signal constructed to modulate and embed the entire media content. By such a two steps approach, individual watermark bits can no longer be differentiated within the media content, nor can a sequential order be identified. Such a novel approach is non-obvious to those familiar in the trade, but once learned by those familiar in the field, can be turned into very useful embodiments that are more robust against the classes of watermark attacks that prior arts are unable to resist.

All possible variations or improvements in embodiments to implement the two step procedures to first embed and incorporate watermark bits into a modulation signal, and then use the modulation signal to modify the host multimedia signal, do not deviate from the basic principles of the current invention, and are intended to be included within the scope of the current claims. The underlining principle of two step embedding approach applies not only to audio watermarking, but to imagery and video watermarking as well. Thus alternative embodiments on imagery, video or other multimedia contents watermarking using the same principle of two step embedding, are intended to be included within the scope of the current invention, whether they are fully described in this document or not.

### INDUSTRY APPLICABILITY

The current invention is novel, useful and non-obvious and can be utilized in the industrial application of but not limited to: information technology, watermarking in audio and visual contents, copyright management, privacy protection, information communication, intelligence and counter-intelligence. Particularly the current invention is useful in creating highly robust and secure audio watermarks for multimedia content copyright protection and other identifying purposes.

The inventor claims:

1. A method of embedding watermark information into a host audio signal contained in audio or video content by a two steps embedding approach, comprising steps of:
1A. constructing a watermark package of N bits of 1s and 0s, containing error correction code.
1B. Selecting N frequency components, with each frequency a multiple of a base frequency F;
1C. constructing a periodical modulation signal having a period of 1/F, based on watermark bits and frequency components that are selected, or based on other calculation from watermark bits;
1D. using the modulation signal to modulate a selected target characteristic quantity of the host audio signal, using phase modulation and other possible modulation method; and
1E. converting the modulated host audio signal into a suitable format for storage and/or delivery.

2. A method of detecting embedded watermark information from a host audio signal contained in audio or video content by a two steps detection approach, comprising steps of:
2A. Providing said host audio signal modulated with watermark information;
2B. extracting modulation signal from the host audio based on modulation method used;
2C. calculate coefficients of frequency components of multiples of F, from modulation signal;
2D. assigning watermark bits of 1 or 0 based on coefficients of frequency components obtained;
2E. using forward error correction code to correct watermark bits, and confirm its correctness;
2F. delivering the extracted watermark information and taking proper response actions.

3. A method in accordance to claim 1, wherein the host audio signal is modulated in step 1D using the modulation signal by modifying the gain of a delayed feedback and add it to the host signal.

4. A method in accordance to claim 2, wherein the gain of a delayed correlation is calculated to extract the original modulation signal as described in step 2B.

5. Methods in accordance to claim 1, wherein the host modulation signal is modulated in step 1D by modifying relative ratios of two sets of frequency components contained in the host signal, or by modifying other characteristics of the host signal.

6. A method in accordance to claim 2, wherein the modulation signal is calculated from the host audio signal by calculating the relative ratio of the two sets of frequency components contained in the host signal, or by extracting the modification applied to the host signal as described in claim 5.

7. An apparatus of embodiment using the method according to claim 1.

8. An apparatus of embodiment using the method according to claim 2.

9. An apparatus of embodiment using the method according to claim 3.

10. An apparatus of embodiment using the method according to claim 4.

11. An apparatus of embodiment using the method according to claim 5.

12. An apparatus of embodiment using the method according to claim 6.
